(19) United States
(12) Patent Application Publication
(10) Pub. No.: US 2016/0007584 A1
(43) Pub. Date: Jan. 14, 2016

(54) FISHING POLE PROTECTORS AND METHODS

(71) Applicant: John D. Calebaugh, Aurora, IL (US)

(72) Inventor: John D. Calebaugh, Aurora, IL (US)

(21) Appl. No.: 14/792,405

(22) Filed: Jul. 6, 2015

Related U.S. Application Data
(60) Provisional application No. 62/022,602, filed on Jul. 9, 2014.

(51) Int. Cl. A01K 97/08; G01B 5/02; A01K 87/00

(52) U.S. Cl. CPC A01K 97/08; A01K 87/00; A01K 87/007; G01B 5/02

(57) ABSTRACT

Various fishing pole protectors and methods are disclosed. In some embodiments, the fishing pole protector comprises a long hollow cylinder with a cap at one end and an opening at the other. An elastic cord is connected to the open end of the cylinder, and a hook is attached to the end of the cord. The cord can be wrapped around the fishing rods and secured to a ring that is also attached to the cylinder at the open end. Wrapping the cord around the fishing pole secures the protector to the pole. The fishing pole protector can cover several rods and bundle them together for carrying convenience and to reduce the risk of breaking a rod.

### CROSS-REFERENCE

This application claims the benefit of U.S. Patent Application No. 62/022,602 filed Jul. 9, 2014, the entirety of which is incorporated by reference herein.

### BACKGROUND

1. Field

This disclosure relates to protection devices for sporting goods, such as devices for protecting fishing poles.

2. Description of Certain Related Art

A fishing pole is an instrument used for catching fish. The pole (also called a rod) is an elongate member with a handle at one end, a tip at the opposite end, and a shaft in between. The pole can have a reel, such as a bait-casting or spinning reel, which can store a length of fishing line. The fishing line can extend through the loops (also called guides) along the length of the pole and be connected to a hook and/or lure. Typically, the pole tapers along its length, such that the tip end is thinner than the handle end, and may be the thinnest part of the pole. Some fishing poles are a “two piece” design that allows the pole to be readily disassembled to reduce the length of the pole, such as being separated into roughly two halves. Some poles are a “one piece” design that are not configured to be readily disassembled but may have better sensitivity.

### SUMMARY

Fishing enthusiasts may take great pride and/or invest considerable money in the fishing poles they use. However, because fishing poles are items that are moved about during both transport and use, and because it can be difficult to monitor the entire elongate length of the fishing pole during such movement, fishing poles can be prone to damage. The tip of the pole can be especially prone to damage because of its location and relatively small cross-sectional size. For example, when the pole is being moved, the tip is typically the leading portion of the pole, and thus is typically the point of impact when a user accidentally strikes the pole against other objects. It can be beneficial to inhibit or prevent breakage of portions of the fishing pole, such as inhibiting or preventing breakage of the tip.

When going fishing, some users employ, or at least bring, multiple poles so as to address different fishing styles, conditions, and types. However, when transporting multiple poles, it can be difficult to effectively control the tips of the poles. Typically, a user will grasp multiple poles at their respective bases, which can result in the pole tips having a tendency to spread out relative to each other. Due to the length of the poles, the spread between the tips may be quite significant. Accordingly, it can be beneficial to control the position of the tips of multiple poles relative to each other.

Some storage devices fully encapsulate the fishing pole. Such containers may require removal of the reel before placement into the container. These containers are typically cylindrical in nature, with screw-type end caps for containment of several poles at one time. However, the poles have a tendency to rattle inside the container, and there is little or no protection inside the tube when tipped from end to end. Also, fishing rods that are manufactured in a one piece format require a very long protection tube, which is cumbersome. The excessive length may occupy a substantial amount of space (e.g., when transporting in a vehicle) and may even require that the container be stored outside (e.g., on a roof rack of the vehicle), which can expose the tube to weather, dirt, and theft.

Certain storage devices do not require the owner to remove the reel, but these are typically large, bulky and expensive. Some are made of a plastic type outer shell, and have foam padding on the inside to absorb shock from impacts. These devices generally consume considerable space, are cumbersome, and are expensive.

Some storage devices are basically pliable sleeves into which the pole is inserted. Some are made of stretchable synthetic nylon type material, which looks similar to netting, that merely surrounds the pole. While these may reduce and prevent some scraping type abrasions to the pole, they provide little or no protection against breakage from impact and crush forces.

Accordingly, there is a need for an improved protection device that addresses one or more of aforementioned, or other, issues. In some embodiments, a protection device includes a rigid hollow tubular body with a longitudinal axis, a first end, and a second end. The tubular body can be configured to receive (e.g., substantially along the longitudinal axis) a tip-end and at least some of the intermediate portion of the fishing pole. Some embodiments do not receive a reel and handle of the fishing pole. Some embodiments include a cap closing the first end. The cap can inhibit the received portion of the fishing pole from passing through the first end. The cap can include a plurality of holes. The second end can be open.

In some embodiments, the device is configured to connect and/or secure the fishing pole in the tubular member. For example, some embodiments have an annular connection member and a securement member configured to couple together. In some embodiments, the annular connection member and the securement member are on the second end of the tubular member. The securement member can be an elastic elongate member, such as a flexible cord. In some variants, the securement member includes a hook and that is configured to releasably connect with the annular connection member. In some embodiments, the securement member is configured to secure the fishing pole in the device without wrapping around and/or connecting with the reel of the fishing pole. In some variants, the securement member is spaced apart from the reel.

In some implementations, the tubular body is configured to maintain its shape and/or is generally non-pliable. In certain implementations, the tubular body has, on a plane perpendicular with the longitudinal axis, a circular cross-sectional shape. In some variants, the tubular body has, on a plane perpendicular with the longitudinal axis, an oval cross-sectional shape. In some embodiments, the tubular body has a longitudinal sidewall that is substantially watertight, such as having no holes, mesh, or the like.

In some embodiments, the tubular body is configured to receive less than 75% of the longitudinal length of the fishing pole. In some embodiments, the tubular body is configured to receive less than 60% of the longitudinal length of the fishing pole.

Certain embodiments of the protection device are configured to float in freshwater with the fishing pole received in the device. Some embodiments have a scale on an outside wall of the tubular body. The scale can be configured to enable a user to determine a length of a fish compared against the scale. Some variants have a strap releasably connected with the tubular body. The strap can be configured to be wrapped around the handle of a plurality of fishing poles to secure the handles relative to each other.

In certain embodiments, a method of securing fishing rods includes inserting a shaft portion of a plurality of fishing rods, tip end first, into a tubular protection device. The tubular protection device can include a longitudinal axis, a securement member, and a connection member. The method can include grasping (e.g., holding, immobilizing, or otherwise) the securement member and/or the connection member. The method can include rotating the tubular protection device around the longitudinal axis and relative to the plurality of fishing rods. Some embodiments include connecting the securement member to the connection member. Certain variants include securing the plurality of fishing rods relative to the tubular protection device.

In some implementations, the method includes maintaining the fishing poles inside the tubular protection device and/or substantially immobilizing the fishing poles relative to each other. Some embodiments include inserting a plurality of fishing rods, with fishing line and a fishing hook or lure attached, into the tubular protection device. Certain variants include inserting the tip end and an intermediate portion of the rod, but not the reel and handle of the rod, into the tubular protection device. Certain embodiments do not include disassembling the shaft portion of the fishing rods.

In some implementations, the securement member has an elongate and/or elastic member, such as a flexible cord. The securement member can include a hook or other connection device. In some variants, the connection member includes a ring. Some embodiments include connecting the hook with the ring. The method can include wrapping a fastening member around a handle portion of the plurality of fishing poles, and securing the fastening member to itself. The method can include maintaining the securement member away from a reel of the fishing pole.

In some embodiments, the tubular body includes a closed first end and open second end. The method can include maintaining a portion of the fishing pole at about a radial center of the second end. For example, some variants include maintaining a portion of the pole that is wrapped by the securement member away from an internal sidewall of the tubular member.

### BRIEF DESCRIPTION OF THE DRAWINGS

Certain features are described below with reference to the accompanying drawings. The illustrated embodiments are intended to illustrate, but not to limit the embodiments. Various features of the different disclosed embodiments can be combined to form further embodiments, which are part of this disclosure.

FIG. 1 is a top perspective view of an embodiment of a protector.

FIG. 2 is bottom rear perspective view of the embodiment of FIG. 1.

FIG. 3 is a front elevation view of the embodiment of FIG. 1.

FIG. 4 is a rear elevation of the embodiment of FIG. 1.

FIG. 5 is a left side elevation view of the embodiment of FIG. 1.

FIG. 6 is a right side elevation view of the embodiment of FIG. 1.

FIG. 7 is a bottom plan view of the embodiment of FIG. 1.

FIG. 8 is a top plan view of the embodiment of FIG. 1.

FIG. 9 is bottom perspective view of another embodiment of a protector.

### DETAILED DESCRIPTION OF CERTAIN EMBODIMENTS

Various protectors are disclosed. The protectors are described in the context of a fishing pole protector, due to particular utility in that context. However, the embodiments and inventions disclosed herein can also be applied to other types of devices and other environments, such as protectors for fishing spears, protectors for arrows, and/or protectors for rifles, shotguns, or other long guns.

### Overview

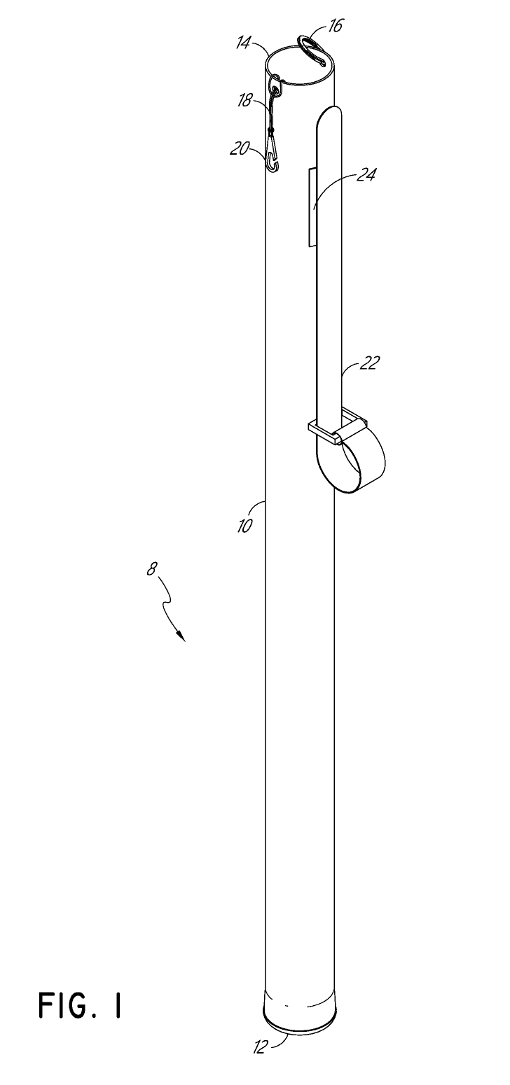

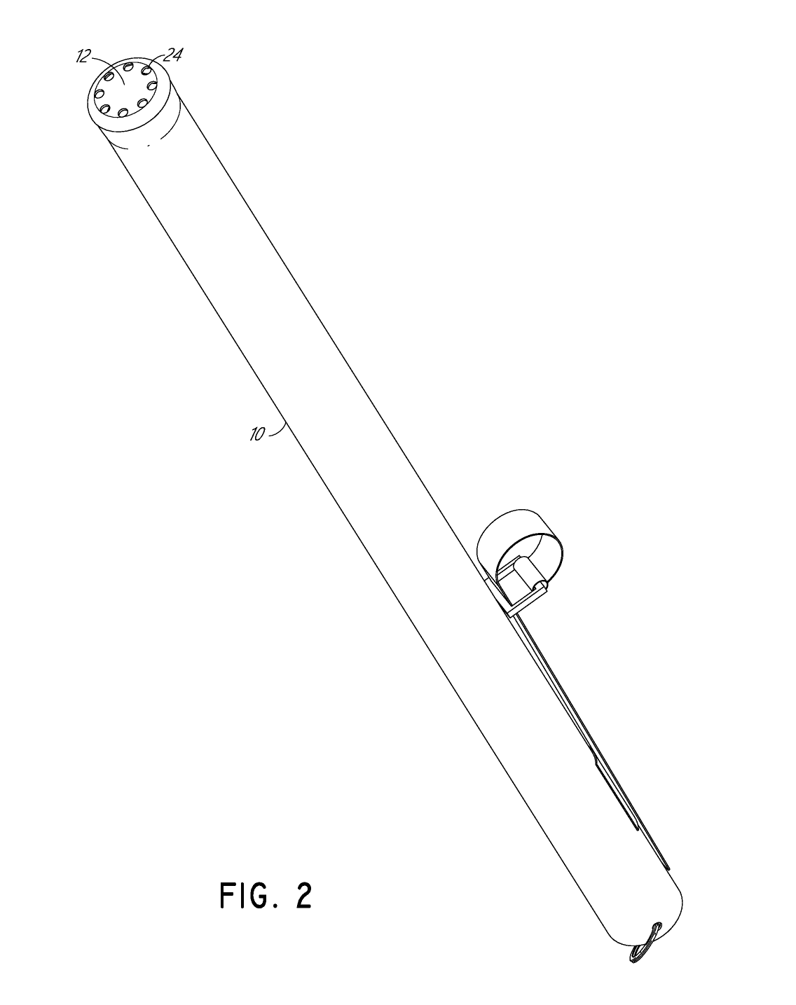

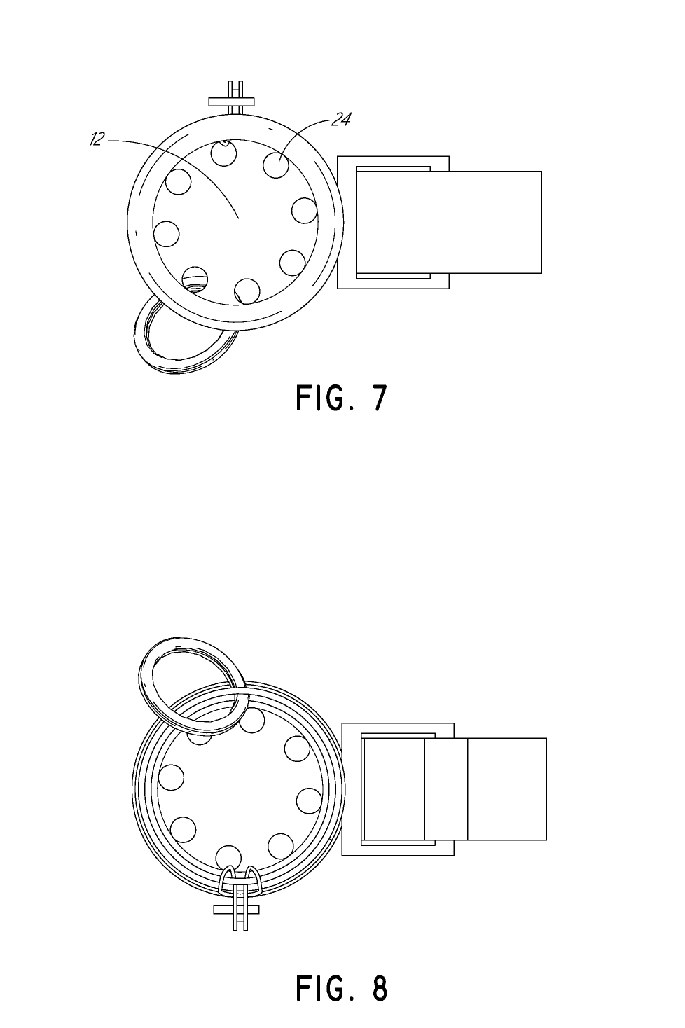

FIGS. 1-8 illustrate an embodiment of a fishing pole protector 8. The protector 8 can be configured to receive and protect one or more fishing poles, as will be discussed in more detail below. For example, some embodiments are configured to inhibit or prevent damage to the tips of the poles, tangling of items (e.g., lines, hooks, and lures) on the poles, and/or crushing of the poles. Some embodiments are configured so as to contain a hook on the pole in a rigid enclosure, thereby protecting the hook from damage and reducing the likelihood of the hook causing injury to a user.

Various embodiments can be used to protect different types of fishing poles. For example, some embodiments are configured to protect bait-casting rods. Some embodiments are configured to protect spin-casting rods, which typically have larger guides than bait-casting rods. Some embodiments are configured to protect ice-fishing rods, which are typically shorter in longitudinal length than bait and spin-casting rods.

As shown, the protector 8 can include an elongate tubular body 10 that is configured to receive the tip and a portion of the shaft of a fishing pole. The protector 8 can also include a connection mechanism that is configured to connect and/or secure the protector 8 with the fishing pole. As will be discussed in more detail below, the body 10 can be configured to receive and protect a portion of the fishing pole, and the connection mechanism can be configured to connect and/or secure the fishing pole in the body 10.

### Tubular Body

As mentioned above, the protector 8 can include a tubular body 10. The body 10 can have a closed first end and an open second end. For example, the first end can be closed with a cap 12 and the second end can have an opening 14. In some embodiments, the cap 12 is fitted into an opening in the first end of the body 10 or is fitted over the first end of the body 10. In some variants, the cap 12 is integral (e.g., unitarily formed) with the body 10.

The cap 12 may have vent holes 24, which can allow air to flow through the body 10 and/or water to drain out of the body 10. The vent holes 24 shown have a generally circular shape. Some embodiments have vent holes 24 that are elongate slots. In some embodiments, the vent holes 24 are around a periphery of the cap 12. Some implementations have vent holes 24 at a radially center region of the cap 12. In some embodiments, the body 10 has one or more longitudinal sidewalls that are substantially watertight, such as having no holes, mesh, or the like. In some variants, the longitudinal sidewall of the body 10 has one or more vent holes.

As illustrated, in some embodiments, the body 10 is cylindrical in shape. In some embodiments, the body 10 has a cross-section shape that is generally: circular, obround, oval, rectangular (e.g., square), hexagonal, or otherwise. As shown, some embodiments have a generally constant cross-sectional shape and/or size along the longitudinal axis of the body 10. Certain variants have a variable cross-sectional a shape and/or size along the longitudinal axis, such as being tapered. In some embodiments, the body 10 is made of a hard plastic. In certain embodiments, the body 10 is made of acrylic, polyvinylchloride, polypropylene, high density polyethylene, or another plastic. In some embodiments, the body 10 comprises a metal (e.g., aluminum or stainless steel) or plant material (e.g., wood or bamboo). Certain variants are adapted for only a one-time use and/or are made of a disposable material, such as cardstock, paperboard, or cardboard.

The body 10 can be rigid (e.g., stiff or unbending) and/or can be configured to maintain its shape. This can aid in shielding fishing poles inside the body 10 from damage. In some variants, the body 10 is configured to substantially maintain its shape when a 20 lb. weight is placed on the body (e.g., at the longitudinal midpoint of the body 10). In some variants, the body 10 is configured to maintain its shape when dropped onto a flat surface from a 6 foot height and in an orientation in which the longitudinal axis of the body 10 is substantially parallel with horizontal. Some implementations have a hardness, measured with the Shore D durometer scale, of at least about: 45, 55, 65, 75, 85, values between the aforementioned values, or other values.

As noted above, the body 10 can be configured to receive the tip and a portion of the shaft of one or more fishing poles. For example, the body 10 can be hollow and can receive the tip and a portion of the shaft of the poles into an inner chamber of the body 10. In some embodiments, the body 10 has an inside width (e.g., diameter), such that the pole can be inserted into the body 10 without needing to remove the lines, hooks, and lures from the rod. Some embodiments are configured to receive multiple rods (as well as the associated lines, hooks, and lures) without needing to remove the lines, hooks, and lures from the rods. Various embodiments are configured to receive one or multiple rods without needing to disassemble the shaft of the rods (e.g., as in two-piece rods). In some embodiments, the body 10 has an inside width of at least about: 2 inches, 3 inches, 4 inches, 5 inches, 6, inches, values between the aforementioned values, or other values.

In certain embodiments, the body 10 is configured to cover only a portion of the length of the rod. For example, some implementations are configured to cover the tip of the rod and an intermediate portion of the rod. Some embodiments are configured to cover a percentage of the length of the rod (measured starting from the tip), such as at least about: 30%, 40%, 50%, 60%, 70%, 80%, percentages between the aforementioned percentages, or other percentages. Some embodiments of the protector 8 do not cover the reel and handle of the rod. Some embodiments of the protector 8 are configured to receive the rod without needing to remove the reel from the rod. In some embodiments, the body 10 has a longitudinal length of least about: 12, inches 18 inches, 24 inches, 30 inches, 36 inches, 42 inches, 48 inches, 54 inches, 60 inches, values between the aforementioned values, or other values. In some embodiments, the body 10 has a longitudinal length of about 30 inches or about 34 inches.

The body 10 can be configured to aid in outdoor and/or sporting use. For example, an outside of the body 10 can be patterned, such as in camouflage or in pictures of fish in their natural environment. In some embodiments, the protector 8 is configured to float, which can aid in retrieving the protector 8 if it is dropped in a body of water. Some variants of the protector 8 are configured to float even when installed on one or more fishing poles. For example, some embodiments are configured to float when at least three fishing poles (including lines, hooks, lures, and reel) are engaged with the protector 8. Certain variants provide at least about 10 lbs. of buoyancy. Some embodiments have padding to aid in securing and/or supporting one or more poles in the body 10. For example, certain embodiments have foam located on an inner wall of the body 10.

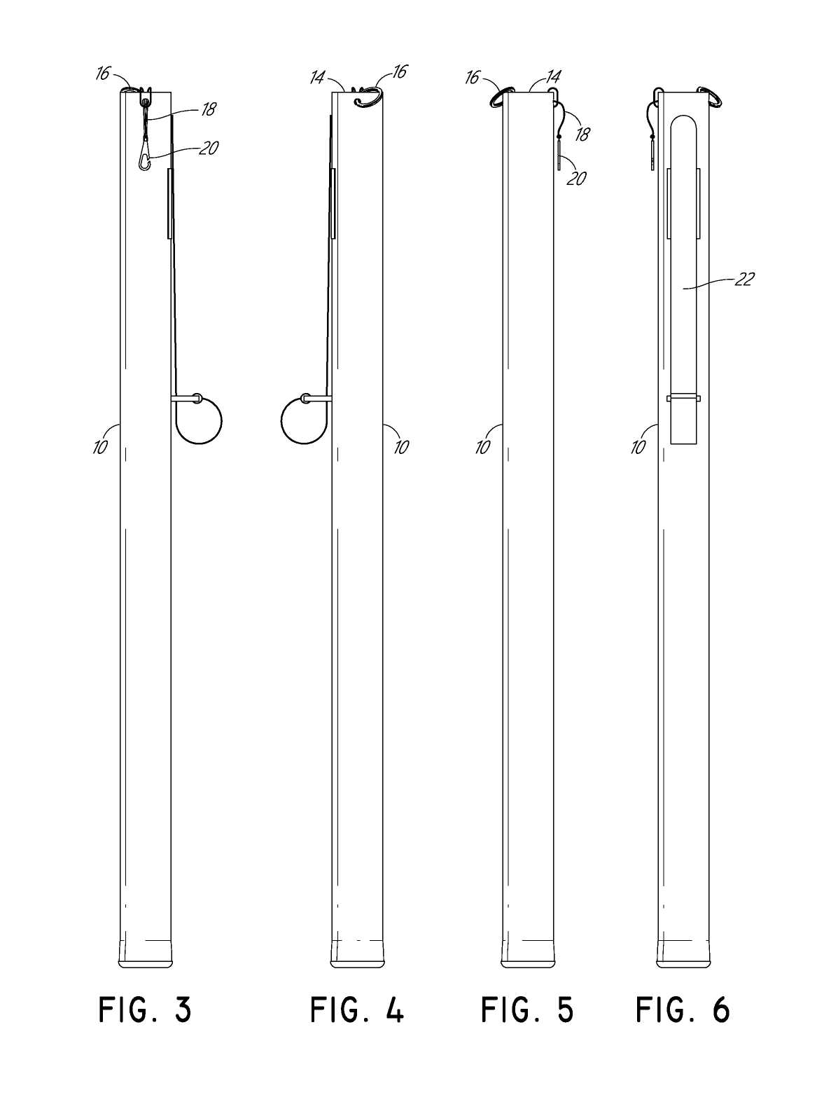

In some embodiments, the body 10 is generally opaque. For example, in certain variants, the portion of the pole received in the body 10 cannot be seen from front, rear, and/or side elevation views, such the vantage points shown in FIGS. 3-6. In some implementations, the body 10 is generally transparent or translucent, such as being at least about 50% transparent.

### Connection Mechanism

As previously indicated, the protector 8 can include a connection mechanism that is configured to connect and/or secure the fishing poles received in the protector 8. In some embodiments, the connection mechanism can include a first connection member, such as a ring 16 (e.g., a O-ring, D-ring, cord loop, etc.). In some embodiments, the ring 16 is connected to the body 10 through a hole in the body 10 near the opening 14. In some variants, the ring 16 engages with an aperture in the body 10, thereby connecting the ring 16 with the body 10.

In some embodiments, the connection mechanism can include a second connection member configured to couple and decouple with the first connection member. AS illustrated, the second connection member can comprise an elongate cord 18. In some embodiments, the cord 18 is elastic, such as being made of rope or bungee cord. In some variants, the cord 18 is generally inelastic, such as being made of wire, chain, or cable. In certain implementations, a first end of the cord 18 is connected to the body 10 through a hole in the body 10 near the opening 14. As shown, the cord 18 can have a length that is less than the longitudinal length of the body 10. For example, as a percentage of the length of the body 10, the cord length can be less than about: 30%, 20%, 10%, 5%, percentages between the aforementioned percentages, or other percentages. In some implementations, the cord 18 does not include a buckle configured to reduce the length of the cord and/or the cord 18 is not configured to be secured against a reel of a fishing pole received in the body 10.

As shown, the second connection member can include a catch, such as a hook 20, such as a carabineer, snap swivel hook, J-hook, or otherwise. In some embodiments, the hook 20 is connected with a second end of the cord 18. The hook 20 can be configured to be attached and detached from the ring 20. For example, the hook 20 can comprise a snap swivel hook that is configured to snap onto, and close around, a portion of the ring 16. In some variants, the hook 20 comprises a J-hook, which is configured to only partially close around the ring 16. In some embodiments, the hook 20 is connected to the body 10 (e.g., through a hole in the body 10) and the ring 16 is attached to the second end of the cord 18.

In some embodiments, the ring 16 is positioned on a generally opposite circumferential side of the opening 14 compared to the cord 18. This can aid in securing the poles stored in the protector 8 in about the radial center of the body 10 and/or can reduce the likelihood of rattling (e.g., due to contact between the received poles and the interior of the protector 8). In some implementations, the ring 16 is circumferentially spaced apart from the cord 18 by about 180°, as shown in FIG. 8.

As mentioned above, the protector 8 can be configured to receive one, or a plurality of, fishing poles. For example, the poles can be inserted, tip end first, into the body 10 via the opening 14. In some embodiments, the cord 18 is wrapped around the pole or poles. For example, the hook 20 can be held stationary and the body 10 and can be rotated about a longitudinal axis of the body 10, thereby wrapping the cord 18 around the pole or poles. In some variants, the body 10 and/or pole or poles are held stationary and the cord 18 and/or hook 20 is wrapped around the pole or poles. In certain variants, the wrapping of the cord 18 stretches the cord, resulting in an elastic force. In some embodiments, the cord 18 can be secured to the ring 16 with the hook 20. In some implementations, the connection of the hook 20 and ring 16 maintains the elastic force in the cord 18 and/or spaces a portion of the fishing pole away from a sidewall of the body 10. In various embodiments, the connection mechanism (e.g., the cord 18) does not connect with and/or apply a force to a reel on the pole. In some implementations, when the cord 18 is securing one or more fishing poles in the body 10, the cord 18 does not substantially extend longitudinally and/or extends substantially radially only.

In certain variants, tension in the cord 18 aids and/or maintains attachment between the ring 16 and the hook 20. For example, the cord 18 can be under at least about 5 lbs. of tensile force. In some variants, the cord 18 is under at least about 10 lbs. of tensile force when the cord 18 is wrapped at least once around a fishing pole received in the protector 8 and the hook 20 is connected with the ring 16.

### Certain Other Features

Some embodiments include a strap 22. The strap 22 can comprise an elongate member with fastening functionality. For example, the strap 22 can include a ratchet or a buckle. In some variants, the strap 22 can include hook and loop fasteners, such as hooks on one side and loops on the other side. As shown, the strap 22 can be attached to a connection point 24 on an outside portion of the body 10, such as for storage of the strap 22 when it is not being used. For example, the strap 22 can be attached to the body 10 by affixing the strap 22 to another piece of hook and loop fastener that is attached to the body 10. In some embodiments, the strap has a length of at least about: 8 inches, 12 inches, 16 inches, 20 inches, values between the aforementioned values, or other values.

The strap 22 can be configured to aid in securing multiple components together. For example, the strap 22 can be removed from the connection point 24 and placed around the handles of the fishing poles, such as poles that are received in the body 10, to bind the handles together. In some embodiments, the strap 22 can be configured to be wrapped around the bodies 10 of a plurality of protectors 8, thus binding the protectors 8 together.

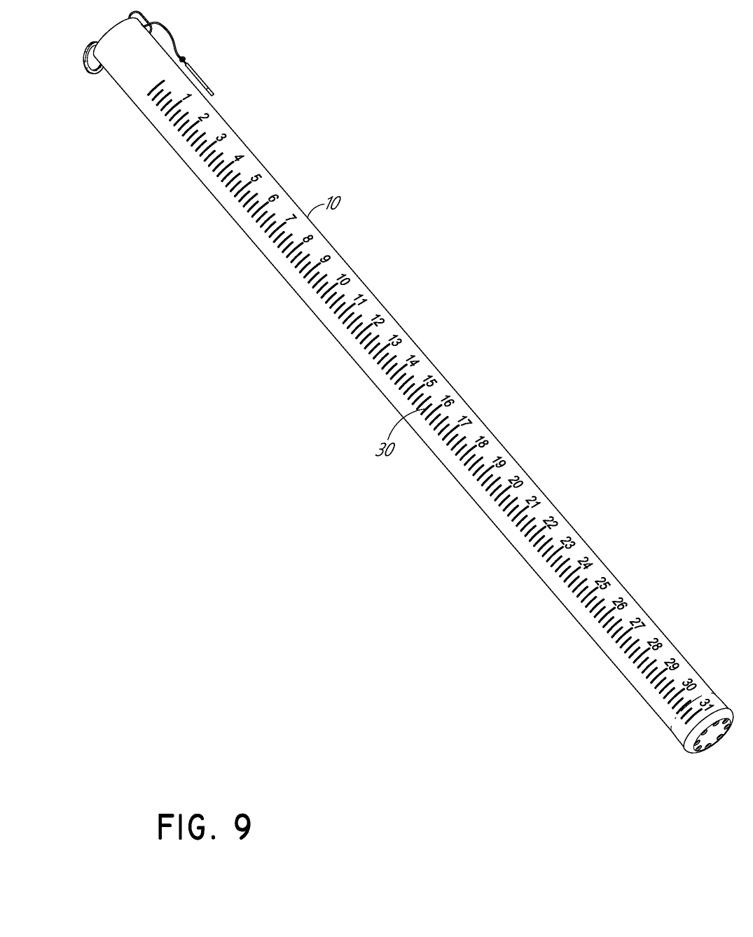

As shown in FIG. 9, some embodiments include a length scale 30, which can be printed or otherwise affixed to the side of the body 10. The scale 30 can allow a user to place a fish next to the scale to ascertain the fish's length. This can aid in complying with regulations relating to the size of fish and/or in providing evidence for competition or otherwise. In some implementations, the scale includes inch and/or centimeter indications.

### CERTAIN TERMINOLOGY

Terms of orientation used herein, such as “top,” “bottom,” “horizontal,” “vertical,” “longitudinal,” “lateral,” and “end” are used in the context of the illustrated embodiment. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular” or “cylindrical” or “semi-circular” or “semi-cylindrical” or any related or similar terms, are not required to conform strictly to the mathematical definitions of circles or cylinders or other structures, but can encompass structures that are reasonably close approximations.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. The term “generally” as used herein represents a value, amount, or characteristic that predominantly includes or tends toward a particular value, amount, or characteristic. As an example, in certain embodiments, as the context may dictate, the term “generally parallel” can refer to something that departs from exactly parallel by less than or equal to 20 degrees.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

### SUMMARY

Although the fishing pole protectors have been disclosed in the context of certain embodiments and examples, the protectors extend beyond the specifically disclosed embodiments to other alternative embodiments and/or uses of the embodiments and certain modifications and equivalents thereof. Various features and aspects of the disclosed embodiments can be combined with or substituted for one another in order to form varying modes of the conveyor. The scope of this disclosure should not be limited by the particular disclosed embodiments described herein. Further, the description and drawings of this application are not intended to limit or define the scope of protection. Rather, the scope of protection is determined by the claims that follow.

Certain features that are described in this disclosure in the context of separate implementations can also be implemented in combination in a single implementation. Conversely, various features that are described in the context of a single implementation can also be implemented in multiple implementations separately or in any suitable subcombination. Although features may be described above as acting in certain combinations, one or more features from a claimed combination can, in some cases, be excised from the combination, and the combination may be claimed as any subcombination or variation of any subcombination.

Moreover, while operations may be depicted in the drawings or described in the specification in a particular order, such operations need not be performed in the particular order shown or in sequential order, and all operations need not be performed, to achieve the desirable results. Other operations that are not depicted or described can be incorporated in the example methods and processes. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Some embodiments have been described in connection with the accompanying drawings. The figures are drawn to scale, but such scale should not be limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, any methods described herein may be practiced using any device suitable for performing the recited steps.

In summary, various embodiments and examples of fishing pole protectors have been disclosed. Although the fishing pole protectors have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Thus, the scope of this disclosure should not be limited by the particular disclosed embodiments described above, but should be determined only by a fair reading of the claims that follow.

The following is claimed:

1. A protection device for at least one fishing pole, the fishing pole comprising a tip-end, a handle opposite the tip-end, an intermediate portion between the tip-end and the handle, and a reel, the device comprising:
a rigid hollow tubular body comprising a longitudinal axis, a first end, and a second end;
the tubular body configured to receive, substantially along the longitudinal axis, the tip-end and at least some of the intermediate portion of the fishing pole, but not the reel and handle of the fishing pole, the received portion of the fishing pole protected by the tubular body;
a cap closing the first end to inhibit the received portion of the fishing pole from passing through the first end, the cap comprising a plurality of holes;
an annular connection member on the second end of the tubular body; and
an elastic elongate securement member on the second end, the elastic elongate securement member configured to releasably connect with the annular connection member.

2. The protection device of claim 1, wherein the elastic elongate securement member comprises a cord and a hook.

3. The protection device of claim 1, wherein the tubular body is configured to maintain its shape.

4. The protection device of claim 1, wherein the tubular body comprises a longitudinal sidewall that is substantially watertight.

5. The protection device of claim 1, wherein the tubular body comprises, on a plane perpendicular with the longitudinal axis, a circular cross-sectional shape.

6. The protection device of claim 1, wherein the tubular body comprises, on a plane perpendicular with the longitudinal axis, an oval cross-sectional shape.

7. The protection device of claim 1, wherein the tubular body is configured to receive less than 75% of the longitudinal length of the fishing pole.

8. The protection device of claim 1, wherein the tubular body is configured to receive less than 60% of the longitudinal length of the fishing pole.

9. The protection device of claim 1, wherein the elastic elongate securement member is not configured to connect with the reel of the fishing pole to secure the device relative to the fishing pole.

10. The protection device of claim 1, wherein the device is configured to float in freshwater with the fishing pole received in the device.

11. The protection device of claim 1, further comprising a scale on an outside wall of the tubular body, the scale configured to enable a user to determine a length of a fish compared against the scale.

12. The protection device of claim 1, further comprising a strap releasably connected with the tubular body, the strap configured to be wrapped around the handle of a plurality of fishing poles to secure the handles relative to each other.

13. A method of securing fishing rods, the method comprising:
inserting a shaft portion of a plurality of fishing rods, tip end first, into a tubular protection device, the tubular protection device comprising a longitudinal axis, an elongate elastic securement member, and a connection member;
grasping the elongate elastic securement member;
rotating the tubular protection device around the longitudinal axis and relative to the plurality of fishing rods;
connecting the elongate elastic securement member to the connection member; and
securing the plurality of fishing rods relative to the tubular protection device.

14. The method of claim 13, wherein securing the plurality of fishing rods relative to the tubular protection device comprises:
maintaining the fishing poles inside the tubular protection device; and
substantially immobilizing the fishing poles relative to each other.

15. The method of claim 13, wherein inserting a plurality of fishing rods, tip end first, into a tubular protection device comprises: inserting a plurality of fishing rods, with line and fishing hook or lure attached, into the tubular protection device.

16. The method of claim 13, wherein inserting a plurality of fishing rods, tip end first, into a tubular protection device comprises: inserting the tip end and an intermediate portion of the rod, but not the reel and handle of the rod, into the tubular protection device.

17. The method of claim 13, wherein the method does not include disassembling the shaft portion of the fishing rods.

18. The method of claim 13, wherein:
the elongate elastic securement member comprises a flexible cord with a hook;
the connection member comprises a ring; and
connecting the elongate elastic securement member with the connection member comprises connecting the hook with the ring.

19. The method of claim 13, further comprising wrapping a fastening member around a handle portion of the plurality of fishing poles, and securing the fastening member to itself.

20. The method of claim 13, further comprising maintaining the elongate elastic securement member away from a reel of the fishing pole.

21. The method of claim 13, wherein the tubular body further comprises a closed first end and an open second end, and the method further includes maintaining a portion of the fishing pole at about a radial center of the second end.
